(19) United States
(12) Patent Application Publication
(10) Pub. No.: US 2012/0182764 A1
(43) Pub. Date: Jul. 19, 2012

(54) INDOOR ILLUMINATION SYSTEM

(76) Inventors: Sarah Anne Mitchell, Oxford (GB); David James Montgomery, Oxfordshire (GB)

(21) Appl. No.: 13/005,641

(22) Filed: Jan. 13, 2011

(51) Int. Cl. F21V 7/22; F21S 8/04; F21V 7/10; F21V 11/00; F21V 21/00; F21S 6/00

(52) U.S. Cl. 362/613; 362/382; 362/257; 362/296.1; 362/311.01; 362/296.01; 362/235; 362/147

(57) ABSTRACT

A lighting system for an indoor room or space is designed to provide a diffuse, glare free source that illuminates the room from the cornice, or a similar location around the join between the walls and ceiling. This may be achieved via a direct source of illumination at the cornice location, or by projecting illumination from a remote source. The lighting system is further designed to allow for illumination of certain areas of the cornice, and hence the room, whilst leaving other parts dark. There are multiple advantages of an adaptable system such as this, but in particular the lighting conditions can be adjusted for optimum lighting levels, for example dimming selected areas when viewing a television.

### TECHNICAL FIELD

The present invention relates to a lighting system, and, more particularly, to a lighting system capable of providing diffuse, glare free lighting in an indoor environment. The lighting system has the further capability of limiting illumination to some areas of this indoor space as selected by a user.

### BACKGROUND ART

Artificial light sources, from the candle to the incandescent bulb to LEDs, tend to be highly localized point sources. There are a few exceptions—fluorescent tube lighting being an obvious example—but even in these cases the light source is confined to a relatively small volume. These light sources can be highly directional, such as spot lighting, and designed to emit into a narrow cone angle. Alternatively, as is the case for traditional incandescent filament lights or cold cathode fluorescent lights (CFLs), the emission is much closer to isotropic, with very little directional or angular control. In either case, emission from a relatively small source can cause problems with glare, either directly if the light source is within the field of view of an observer, or indirectly through reflections off other surfaces. Reflections from TVs, for example, can make the display difficult to see and spoil the viewing experience. Similarly, point sources can cast strong shadows, which can be aesthetically displeasing and leave some areas in an environment in shadow, thus making objects hard to see.

Some prior art has already tried to address aspects of the limitations above.

Ser. No. 05/386,353 (Dominic Battaglia, Jan. 31, 1995) discloses surface mounted lighting units, comprising light source, housing 10, and cover 11 (see FIG. 1). The system described is a modular arrangement designed to house fluorescent tubes in order to provide uniform illumination in an environment such as a kitchen.

JP24349165 (Matushita Electric Works Ltd., Dec. 9, 2004) discloses an indirect light source designed for a cornice, illustrated in FIG. 2, and consists of a light source 20 located behind a front panel 21, which is disguised to look like the wall and/or ceiling.

WO09504897 (Neon and Cathode Systems, Feb. 16, 1995) discloses a modular cove lighting system which uses fluorescent tubes 30 within a housing 31, as shown in FIG. 3. The publication discloses a method to dim the lights uniformly, and claims coloured light sources as well as white light.

Another solution to reduce glare is to illuminate a large area indirectly, by projecting light from a smaller source. An example of this type of system could be a LED light source with optics such that it becomes side emitting into a narrow angular range.

US07524098 (Dicon Fibreoptics ltd., Apr. 28, 2009) discloses a side emitting optic element for an LED light source 40, as shown in FIG. 4. The device is designed to provide a light source for lightguides or reflectors by using a combination of refracting 41, and totally internally reflecting (TIRing) 42, surfaces.

Ser. No. 06/607,286 (Lumileds lighting US, Aug. 19, 2003) discloses another example of a side-emitting optic element for an LED light source 50, as shown in FIG. 5. This design also uses refracting 51 and TIRing 52 surfaces to direct the light. As with the previous example this is designed for use with lightguides or reflectors.

As is shown, examples of side emitting LEDs in the prior art are known. However, these side-emitting LEDs are designed for in-coupling to backlights or light guides, and are therefore designed with rather different criteria in mind. A major difference to the ideal side-emitting light source for projection lighting is the angle into which light is emitted; for a projection source the angular range should be as narrow as possible, whereas for in-coupling to a backlight a larger spread of angles is required in order to facilitate extraction from the backlight.

The prior art outlined above still leaves significant scope for improvement in indoor lighting. There is extremely limited control over the direction of illumination, and thus which areas should be illuminated. As well as limiting a users' control over the lighting conditions in a room this is also inefficient, since light is wasted through illuminating areas where it is not needed or wanted.

### SUMMARY OF INVENTION

There are problems with existing lighting systems, as described in the background section, which include issues with glare from small point or narrow line sources; strong shadowing from the same; lack of control over lighting directionality, and reduced efficiency caused by emitting light into directions where it is not needed. Side emitting sources in the prior art are not ideal for projection lighting because they are designed to emit into a relatively wide angular range, as is necessary for in-coupling and subsequent extraction in lightguides.

The present invention provides a lighting system which is able to improve issues with conventional light sources by introducing a method of providing light to a room from a cornice or equivalent location near the upper part of walls. Subsequently this area will be referred to as the cornice, but refers to the same location whether or not a cornice molding is present. The lighting system in accordance with the invention includes directional control such that light can be transmitted from some parts of the cornice but not all. The emission of light from the cornice may be achieved either directly from a light source positioned at that location, or by projecting light from another point in the room such that it reflects off the cornice.

Advantages of such a system are multiple; to achieve the same light levels in the room as from a single point source, the illuminance around a cornice can be much lower, hence the light source is more comfortable to look at and problems with glare are greatly reduced or eliminated. A light source from multiple locations will also greatly reduce shadowing.

By providing directional control, light levels in various parts of a room can be adjusted to give optimum brightness in each, and the efficiency of the lighting system will be increased through the reduction of wasted light. Further advantages include the fact that light sources designed to project light towards the cornice can also be retrofitted in many locations since ceiling lights are often fitted in the centre of a room, and could easily be replaced with a projection light source.

According to one aspect of the invention, a lighting device for lighting an area includes: a strip illuminating structure for distributing light from respective sections thereof; and a light source controllable to selectively provide the light to the sections.

According to one aspect of the invention, at least two sections of the strip illuminating structure are configured to distribute light in a direction different from one another.

According to one aspect of the invention, the strip illuminating structure comprises a light guide including at least one light receiving surface and a light exit surface, and the light source comprises at least two light emitting devices in-coupled to the at least one light receiving surface.

According to one aspect of the invention, the light guide comprises a plurality of extraction features configured to extract light from the light guide in one or more predetermined directions.

According to one aspect of the invention, the light source comprises an optic configured to project light having a predetermined beam direction.

According to one aspect of the invention, the optic is a side-emitting optic having an optical axis arranged parallel to the light exit surface, the optic including: a light receiving surface; a collimating surface arranged between the light receiving surface and the light exit surface; and a reflective surface configured to reflect light received at the light receiving surface into a predetermined range of angles relative to a plane perpendicular to the optical axis.

According to one aspect of the invention, the reflective surface is at least one of a totally internally reflecting surface, a metallic surface or a mirrored surface.

According to one aspect of the invention, the light source is configured to provide an illumination pattern through refraction.

According to one aspect of the invention, the optic includes a plurality of optics.

According to one aspect of the invention, a totally internally reflective surface of the optic is circularly symmetric.

According to one aspect of the invention, the light source comprises a scanning mirror, and the lighting device further comprising a controller configured to control a position of the scanning mirror.

According to one aspect of the invention, the light source further comprises a plurality of light emitting diodes (LED) and a plurality of scanning mirrors, each LED of the plurality of LEDs corresponding to one scanning mirror of the plurality of scanning mirrors.

According to one aspect of the invention, a method for lighting an interior space having at least one wall and a ceiling adjacent to the wall, the at least one wall and ceiling forming at least one corner portion includes: using a strip illuminating structure to provide light to the at least one corner portion; and controlling a light source to selectively distribute the light from sections of the strip illuminating structure.

According to one aspect of the invention, controlling includes controlling the light source to distribute light from two sections of the strip illuminating structure in directions different from one another.

According to one aspect of the invention, providing light to the at least one corner portion includes placing the light source in the at least one corner portion.

According to one aspect of the invention, providing light to the at least one corner portion includes projecting light into one or more predetermined sections of the strip illuminating structure.

According to one aspect of the invention, controlling the light source includes controlling at least two light sources.

According to one aspect of the invention, the method further includes selecting a length of the light source to correspond to a length of the wall.

According to one aspect of the invention, the method further includes placing the light source on the ceiling a predetermined distance from the at least one wall.

According to one aspect of the invention, controlling the light source includes controlling at least two light sources, a first light source of the at least two light sources positioned on the ceiling and a second light source of the at least two light sources positioned at the cornice.

According to one aspect of the invention, placing the light source on the ceiling includes placing the light source in a center of the ceiling.

According to one aspect of the invention, the method further includes arranging the light source to illuminate at least a portion of the ceiling so as to reflect light from the ceiling into the interior space.

According to one aspect of the invention, the method further includes projecting light from the at least one light source toward the cornice, and reflecting the projected light from the cornice into an area of the interior space.

According to one aspect of the invention, the method further includes using a reflective sheet at the cornice to reflect the projected light from the cornice.

According to one aspect of the invention, using a reflective sheet includes using a reflective sheet that reflects light using at least one of mirror surfaces or total internal reflection.

According to one aspect of the invention, the method further includes placing the light source remote from the cornice, and using a scanning mirror to project light toward the cornice.

According to one aspect of the invention, the method further includes collimating the light prior to projecting the light toward the cornice.

According to one aspect of the invention, controlling the light source includes using a light source comprising a light guide as the light source, said light guide having at least one input surface for receiving light and an exit surface for emitting the received light;

According to one aspect of the invention, the method further includes configuring the exit surface of the light guide to compensate for fall-off intensity proportional to cost.

According to one aspect of the invention, controlling the light source includes using extraction features having a prism-based geometry to control a direction of light emitted by the light source.

According to one aspect of the invention, using extraction features includes arranging the extraction features such that a feature density in a given area corresponds to a distance of the extraction features from the at least one input surface.

According to one aspect of the invention, controlling the light source includes using a pre-existing light source in the interior space.

According to one aspect of the invention, the method further includes controlling an emission brightness from portions of the light source to control an illumination pattern in the interior space.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, like references indicate like parts or features:

FIG. 1 illustrates a conventional ceiling lighting arrangement.

FIG. 2 illustrates a conventional cornice lighting arrangement.

FIG. 3 illustrates a conventional cornice lighting arrangement.

FIG. 4 shows a conventional side-emitting optic.

FIG. 5 shows a conventional side-emitting optic.

FIG. 6 is an exemplary room showing the basic concept of a illumination system in accordance with the present invention.

FIG. 7 shows an exemplary design of a lightguide-based light source in accordance with a preferred embodiment of the present invention.

FIG. 8 illustrates an alternative location for the light source.

FIG. 9 illustrates an exemplary combination of cornice-located and ceiling located lightguide light sources.

FIG. 10 demonstrates the basic premise of the sheet lighting concept.

FIG. 11 illustrates an exemplary design for a side-emitting optic for use in the sheet lighting embodiment.

FIG. 12 illustrates the illumination distribution for the optic in FIG. 11.

FIG. 13 shows the cos⁴θ distribution of light from a point source on a planar surface.

FIG. 14a illustrates one option for improving the optic to correct for cos⁴θ illumination pattern, viewed from the side.

FIG. 14b as FIG. 10a, but showing the optic viewed from the top.

FIG. 15 illustrates the side emitting optic with the circular symmetry of the TIRing surface broken to correct for cost distribution.

FIG. 16 shows an alternative optic designed to create a smaller angular illumination pattern.

FIG. 17 illustrates an illumination pattern from an optic such as shown in FIG. 16.

FIG. 18 illustrates an exemplary ceiling illumination system.

FIG. 19 illustrates an exemplary geometry for a ceiling illuminating optic.

FIG. 20a illustrates an exemplary geometry for a directionally specific ceiling illuminating optic.

FIG. 20b illustrates the optic shown in FIG. 20a.

FIG. 21 shows an alternative method of creating sheet lighting effect through a scanning mirror arrangement.

FIG. 22 shows the scanning mirror and collimating optic in more detail.

FIG. 23 illustrates the scanning mirror embodiment with light sources located in multiple points about a room.

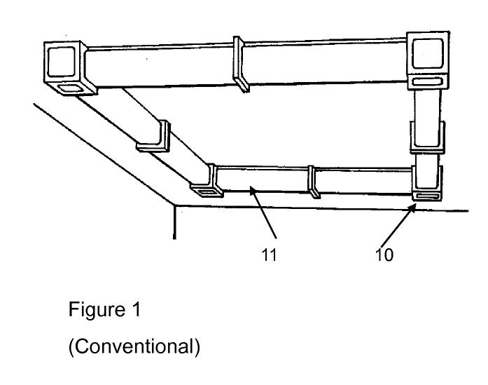

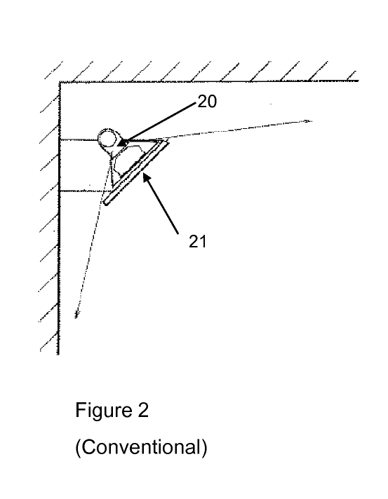

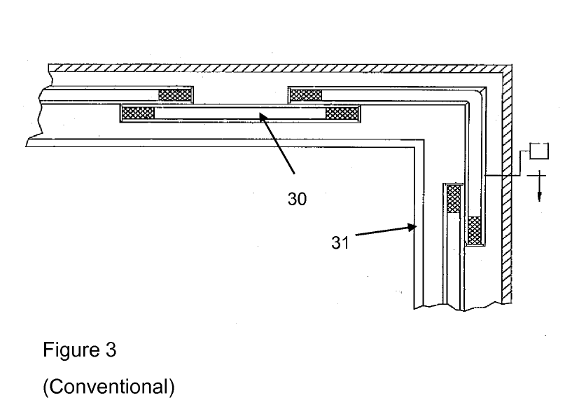

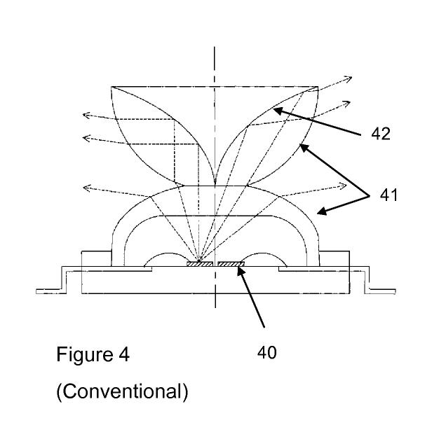

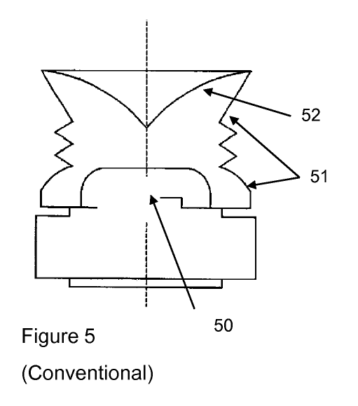

### DESCRIPTION OF REFERENCE NUMERALS

10. Housing for the ceiling-based light sources
11. Cover for same.
20. Light source for cornice light
21. Cover to hide light source. Designed to blend in with wall/ceiling.
30. Light source (fluorescent tube)
31. Housing for fluorescent tube.
40. LED
41. Optic refracting surfaces
42. Totally internally reflecting surface of optic
50. LED
51. Refracting surfaces of optic
52. Optic totally internally reflecting surface
60. Extended area light source
60a. Light input surface
60b. Light exit surface
61. Section of floor which is illuminated
62. Controller
70. LED
71. Extraction features. Extract light with narrow angular range
72. Illustration of restricted illumination angle from light guide
73. Width of lightguide
74. Length of lightguide
75. Height of lightguide
80. Alternative positioning of light source away from cornice
100. LED
101. Side-emitting optic
102. Reflection/scattering controlling panels
103. Example light path.
110. LED location
111. The collimating part of the optic design
112. TIRing surface to deflect light sideways
113. Exit surface for light from optic
114. Optic axis
110. TIRing surface
111. Exit surface for light from optic. This may be shaped or flat.
160. Exit surface
161. TIRing surface
190. Additional TIRing surface
191. New exit surface
210. Scanning mirror
220. Scanning motor to control mirror angle
230. Scanning mirror and light source assembly
231. Area illuminated by 230.

### DETAILED DESCRIPTION OF INVENTION

The present invention provides a device and method for lighting an area, such as an interior space (e.g., a room having walls and/or a ceiling). In accordance with the invention, a strip illuminating structure distributes light from respective sections of the structure, and a light source is controlled to selectively provide the light to the sections of the structure. The strip illuminating structure and/or light source can be configured such that light from two different sections of the strip illuminating structure are distributed in different directions. The strip illuminating structure can include a light guide having at least one light receiving surface (e.g., a surface that receives light from a light source) and a light exit surface, e.g., a surface from which light is emitted. The light source can include a light generation device that is selectively switchable to control the emission of light. For example, the light generation device may be configured to be selectively switchable such that light emitted from the device is output from part but not all of the light exit surface. In this manner, directional control of the light emitted from the light exit surface is achieved, thereby enabling a target illumination level to be achieved in the interior space. Further, the strip illuminating structure and/or one or more light sources may be configured such that light emitted by respective light sources is in-coupled to respective light receiving surfaces of the light guide.

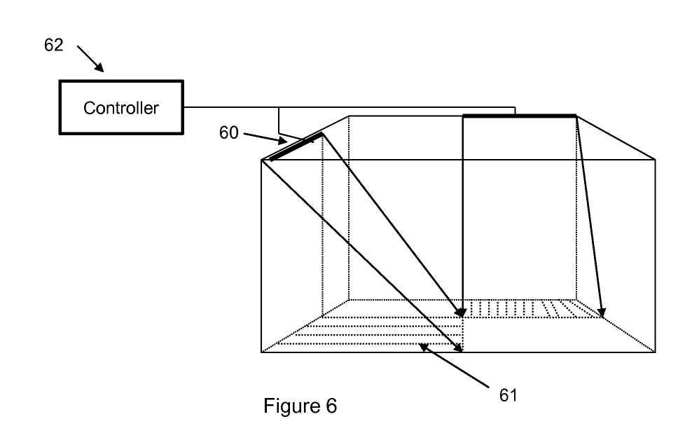

A preferred embodiment of an exemplary lighting system in accordance with the present invention is illustrated in FIG. 6. In this embodiment, a large area light source 60 illuminates a room or other interior space. This light source may be controllable via controller 62 to illuminate selected areas of the room 61 with variable brightness (e.g., create an illumination pattern), in order to provide optimum lighting conditions at a given time or according to user preference. The controller may be (but is not limited to) a switch, a computer or network, or a signal from a sensor.

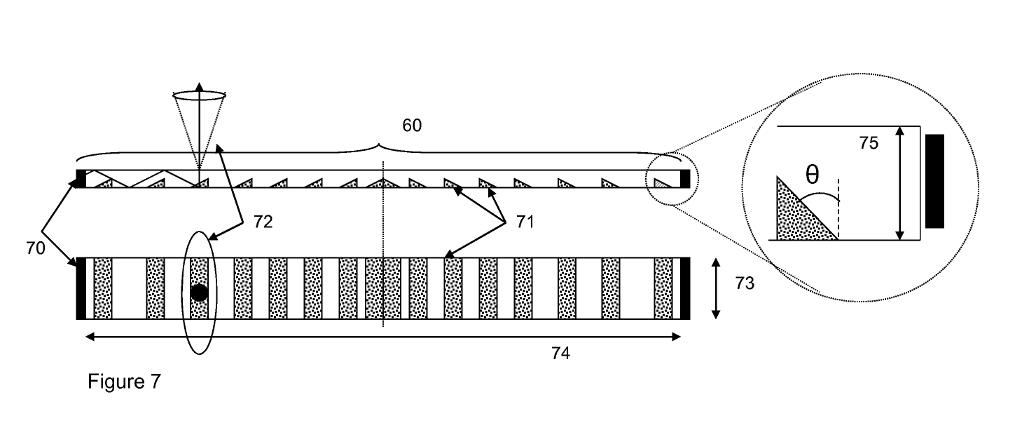

In this preferred embodiment the room or other indoor space is illuminated by one or more lightguides, as illustrated in FIG. 7, and can include a light input surface 60a and a light exit surface 60b. The light sources that provide the illumination are located at both ends of the lightguide, and light from the light sources is in-coupled to the light input surface. These light sources may include, but are not limited to, LEDs 70. The LEDs may be colour (RGB) or white light (blue or UV LED and phosphor) sources. The light sources can be configured to be switchable independent of each other (e.g., one light may be switched on while another light source may be switched off).

The combined lightguide length 74 per wall should be sufficient to substantially span the length of each wall, and the preferred embodiment uses one light guide per wall. For example a wall 3 m in length would use a lightguide slightly less than 3 m long, allowing sufficient space for the one or more light sources and fittings at both ends. The lightguides in this embodiment are located at a predetermined section of the room, such as at the position where a cornice would be found, around the join between the walls and ceiling in a room. The width 73 is similar to that of a typical cornice molding—10-15 cm. The lightguide thickness 75 will be controlled by the size of the light source, but should be no more than about 1 cm, and preferably less; sufficient to allow efficient in-coupling from the light source. The lightguides preferably are made of a transparent material such as PMMA.

Light is in-coupled into the lightguide from the light sources, and propagates through the lightguide by total internal reflection (TIR). TIR is frustrated by extraction features 71 within the lightguide, thus providing illumination to the room or other space. The extraction features are designed to extract light with a specific (predetermined) angular direction 72, for example, perpendicular to the length of the lightguide. By controlling the angle at which light is out-coupled from the light guide, a specific area in a room may be illuminated by having one part of a light guide illuminated. Thus, a user may choose to have some parts of the room lit whilst leaving others dark. Extraction features which achieve this angular control over extraction direction could have, but are not limited to, prism-based geometry. An example of this is triangular cross-section prisms arranged along the width of the lightguide, as shown in FIG. 7. A suitable prism angle, θ, to achieve extraction perpendicular to the lightguide is between 45-50°, but optionally the prism face angle could also be dependent not only on desired extraction angle but also position within the lightguide.

The extraction features may be arranged such that extraction is uniform over the whole or part of the length of the lightguide, thus using a higher density of extraction features further from the source. If the lightguide is illuminated from both ends the extraction features, the extraction features are symmetric about the centre of the lightguide. In this case, the extraction feature density may be designed such that, by illuminating only one end of the lightguide, light is extracted only from the near half of the lightguide. In this way, substantially uniform illumination of selected parts of the room may be achieved.

A second embodiment in accordance with the present invention is substantially similar to the first embodiment, but may use more than one lightguide per wall, with light sources positioned as to satisfactorily illuminate the lightguides.

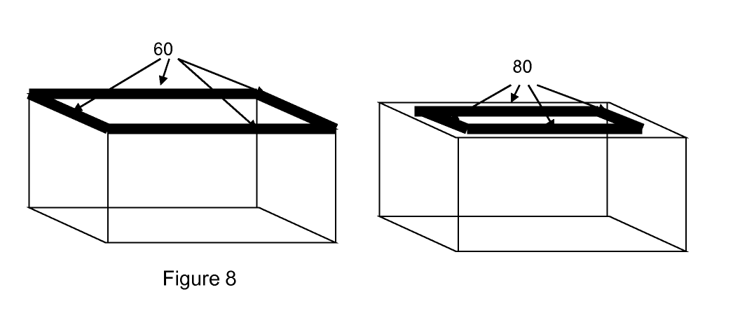

In a third embodiment in accordance with the invention, illustrated in FIG. 8, the light source may be as described above, but located on the ceiling 80, away from the walls (e.g., a predetermined distance from the walls), in order to direct light towards the middle of the room or interior space. This may be particularly desirable in, but is not limited to, larger areas where a cornice mounted light source 60 may not provide sufficient illumination further away from the walls.

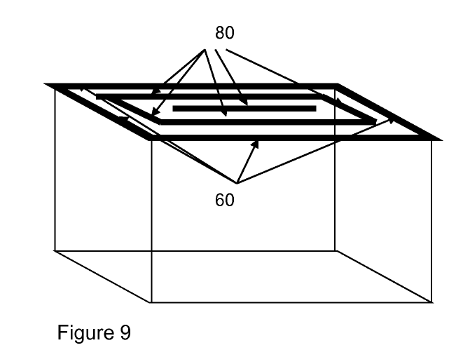

A fourth embodiment in accordance with the present invention describes a combination of the previous embodiments, with light guide light sources located both on the cornice 60 and the ceiling 80 for optimum room illumination. This embodiment is illustrated in FIG. 9.

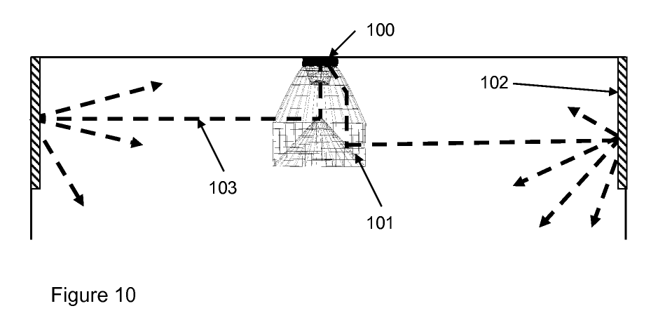

In a fifth embodiment in accordance with the present invention, illustrated in FIG. 10, the light source 100 is much smaller than the illumination area, and is located away from the cornice, for example in the centre of the ceiling. In this case the light source is in-coupled to an optic 101 which projects illumination 103 towards the cornice, where the light is then redirected into the room via reflection or scattering. For example, the light source maybe configured to project light from a light exit surface toward a target area.

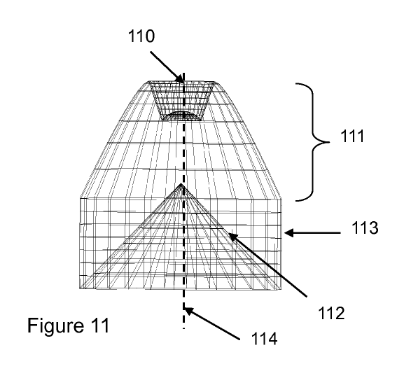

The light source may include, but is not limited to, one or more LEDs coupled to a side-emitting optic. The optic material should be a transparent material such as glass or PMMA. An example optic geometry is shown in FIG. 11. In this example the optic first collimates the LED output, positioned at 110 (e.g., a light receiving surface), through a combination of refraction and total internal reflection on collimating surface 111 (which is arranged between the surface 110 and the surface 113), and then diverts the light by total internal reflection on surface 112 (e.g., a reflective surface 112). The light exits the optic through surface 113, which may be cylindrical or shaped for further control over the exiting light.

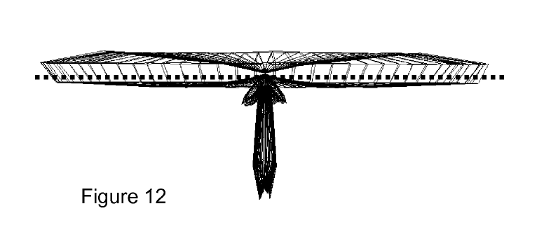

Assuming that the optic axis 114 of the optic shown in FIG. 11 is aligned in the vertical direction (parallel to the surface 113 and perpendicular to the surface 110), the collimating surface 111 is designed to form light into a vertical beam. The TIRing surface 112 then totally internally reflects the light into a narrow range of angles about the horizontal (e.g., the plane perpendicular to the optic axis), by positioning the surface 112 at an angle of approximately 45 degrees to the vertical. With a circularly symmetric optic as shown in FIG. 11 the emission will be symmetric in the horizontal plane. The angular distribution of light exiting the optic may be seen in FIG. 12, and is notable in being limited to within approximately ±8 degrees of the horizontal; a small angular range suitable for illuminating a narrow strip of the walls. The dashed line in FIG. 12 indicates the horizontal plane; illumination is circularly symmetric in this plane.

The reflecting and/or scattering surface from which the light reflects or scatters on reaching the walls may be bare wall or purpose designed reflector sheet 102. In the latter case, the reflector sheet may be designed to control the reflection direction by carefully directed metalized mirrored surfaces, or reflection through TIR in angled prisms. As in embodiment one, the angle at which light is designed to illuminate the room can be controlled by the angle of the reflecting surface, but may, for example, be chosen to be perpendicular to the length of the reflector strip.

This lighting arrangement of LED or other light source and optic may be retrofitted to an existing ceiling light fitting, thus minimizing or eliminating the need for expensive and disruptive installation of new lighting equipment.

A sixth embodiment in accordance with the invention describes an optic identical to that in the previous embodiment, shown in FIG. 11, but with a metallic or otherwise mirrored surface 112 instead of a TIRing surface.

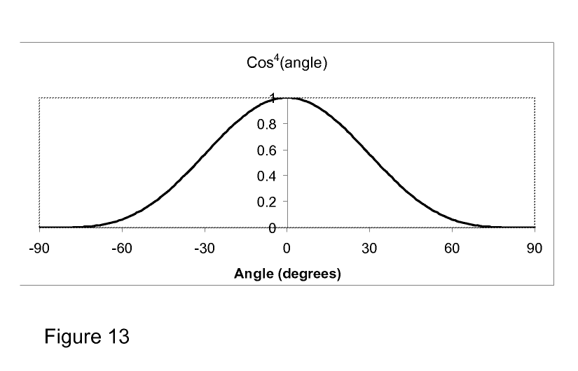

A seventh embodiment in accordance with the invention is as per embodiment five except the exit surface of the optic is specifically designed to compensate for the fall-off in intensity, proportional to cost, which occurs when a point source emits light onto a planar surface such as a wall, as is illustrated in FIG. 13. For uniform illumination of a space this cost illumination pattern is not ideal, and so the optic is shaped to provide more uniform illumination.

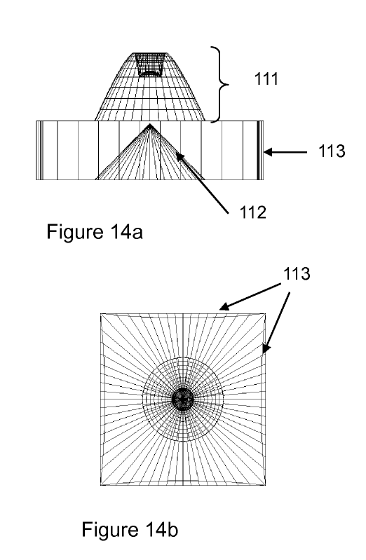

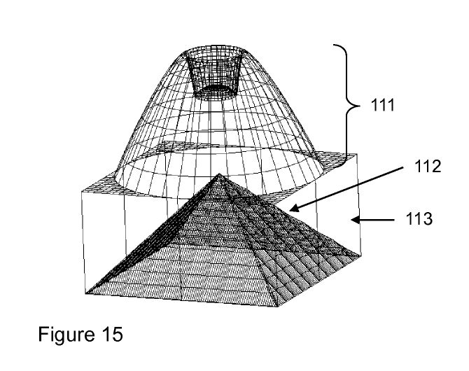

An example of such an optic may be substantially the same as described in embodiment five, with a collimating surface 111 and TIRing surface 112, and an exemplary geometry is illustrated in FIGS. 14a and 14b. Angular control which breaks the circular symmetry of the default illumination pattern may be achieved entirely through refraction at the exit surface 113 by shaping the exit surface. Circular symmetry of the TIRing surface 112 may also be broken to aid in obtaining the optimum illumination pattern, as shown in FIG. 15.

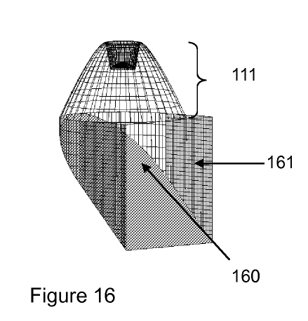

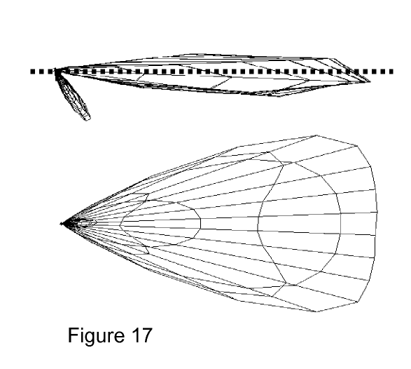

An eighth embodiment in accordance with the invention is as per embodiment five except in this case the optic is designed to provide selective illumination to illuminate specific areas of cornice. The same may be achieved through multiple optics and more than one light source. An example of an optic with a restricted angular range in the horizontal plane is shown in FIG. 16. The optic may be substantially similar to that in embodiment five, except that the TIRing surface 160 is no longer circularly symmetric. In addition, the exit face 161 may be flat or shaped to further control the directionality of the emitted light. An example emission distribution from an optic such as this is shown in FIG. 17. FIG. 17 shows two views of the same illumination distribution; a side on view, with the horizontal plane shown as a dashed line, and a view from above, showing the limited angular range in the horizontal plane. A number of these optics may be combined to provide illumination to all parts of the room, or, by selecting which optics are illuminated at a given time, control the light levels in different parts of the room.

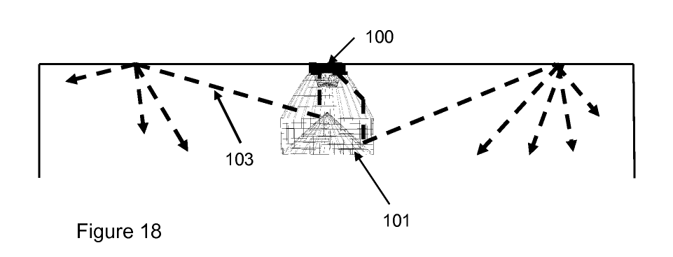

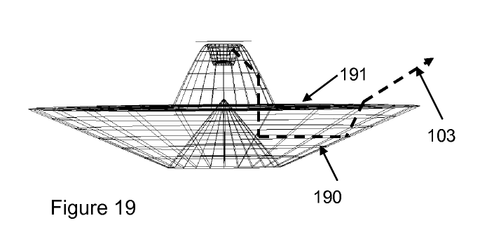

A ninth embodiment in accordance with the invention is as per embodiment five, but describes illumination of a ceiling area rather than the cornice, as illustrated in FIG. 18. An LED 100 and single optic source 101 illuminate the ceiling area and the illumination is then reflected into the room. The optic geometry may be substantially as per the optic in embodiment four five, but with the TIRing surface 112 at a different angle to direct light onto the ceiling. Alternatively an additional TIRing surface may be added 190, and a new exit surface 191, as illustrated in FIG. 19.

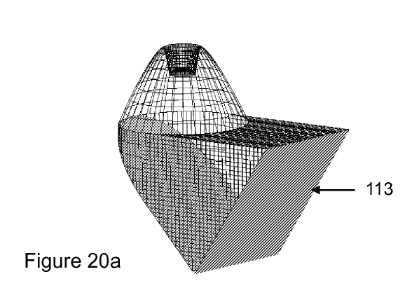

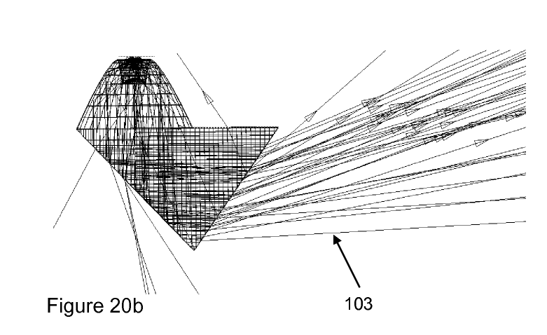

A tenth embodiment in accordance with the invention describes a variation of embodiment eight using a multipart optic, similar to that described in embodiment seven, to provide selective illumination to parts of the ceiling. An example of a possible geometry is shown in FIG. 20 a and b, where the angle of the exit surface, 113, is chosen to refract light 103 towards the ceiling. The optic geometry may be designed to provide uniform brightness over the parts of the ceiling which are illuminated, correcting for the natural radial decrease in illuminance.

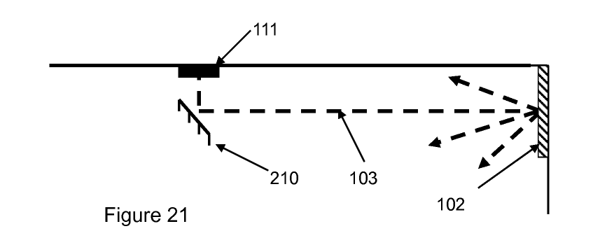

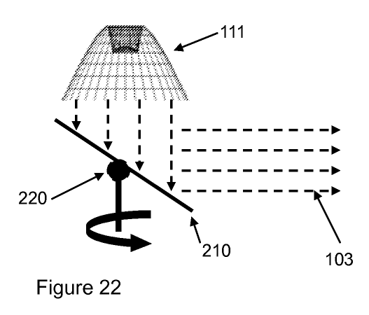

An eleventh embodiment in accordance with the invention, illustrated in FIG. 21, the light source is again remote from the cornice and light is collimated and projected towards the cornice by a scanning mirror 210. By scanning the mirror with a high frequency along the areas to be illuminated the entire cornice may be illuminated. The optic and mirror is illustrated in more detail in FIG. 22. The collimator 111 may be very similar to that used in the optics described in previous embodiments, with the omission of the TIRing surface that deflects the light sideways. The mirror 210 is positioned below the collimator, and is controlled by a motor system 220. By allowing the scanned beam a larger proportion of time on the areas further (radially) from the source, the cos⁴θ effect from illuminating a plane surface with a point source may be compensated for. Alternatively, the brightness of the light source may be dimmed according to beam direction to achieve the same effect. The reflection or scattering of the light at the cornice may again be controlled by panels 102.

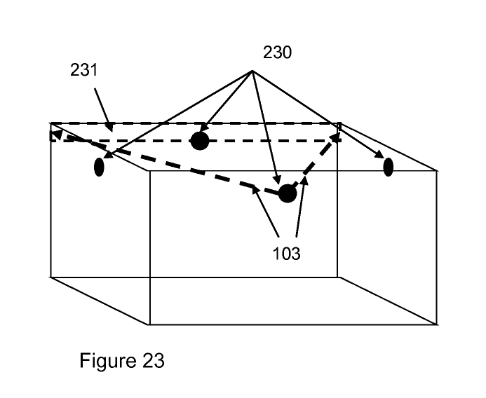

In a twelfth embodiment in accordance with the invention, illustrated in FIG. 23, the light beam 103 is again directed with a scanning mirror, but in this case more than one LED and mirror light source is used 230 (e.g., each LED corresponding to at least one scanning mirror). In this case the light sources may all be positioned in one location (such as the centre of the room), or, for example, separately on the opposite wall to that intended to be illuminated. Each mirror illuminates a wall or section of wall 231.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

### INDUSTRIAL APPLICABILITY

This invention could be utilized in both residential and commercial environments. The relative simplicity of the design requires minimal rewiring, and in some cases it might be possible to retrofit the sheet lighting straight into existing ceiling light fixtures.

The high level of user control will allow this lighting system to be used in a wide range of conditions, for example, general lighting, or subdued background lighting for presentations or watching display equipment such as televisions, without the risk of strong glare interrupting the viewing experience.

The ability to select only certain sections of the lighting system to illuminate will introduce opportunities for energy savings.

A further possibility exists to link the control of this lighting system to a central network and automate the system response o certain conditions or instructions.

1. A lighting device for lighting an area, comprising:
a strip illuminating structure for distributing light from respective sections thereof; and
a light source controllable to selectively provide the light to the sections.

2. The lighting device according to claim 1, wherein at least two sections of the strip illuminating structure are configured to distribute light in a direction different from one another.

3. The lighting device according to claim 1, wherein the strip illuminating structure comprises a light guide including at least one light receiving surface and a light exit surface, and the light source comprises at least two light emitting devices in-coupled to the at least one light receiving surface.

4. The lighting device according to claim 3, wherein the light guide comprises a plurality of extraction features configured to extract light from the light guide in one or more predetermined directions.

5. The lighting device according to claim 1, wherein the light source comprises an optic configured to project light having a predetermined beam direction.

6. The lighting device according to claim 5, wherein the optic is a side-emitting optic having an optical axis arranged parallel to the light exit surface, the optic comprising:
a light receiving surface;
a collimating surface arranged between the light receiving surface and the light exit surface; and
a reflective surface configured to reflect light received at the light receiving surface into a predetermined range of angles relative to a plane perpendicular to the optical axis.

7. The lighting device according to claim 6, wherein the reflective surface is at least one of a totally internally reflecting surface, a metallic surface or a mirrored surface.

8. The lighting device according to claim 5, wherein the light source is configured to provide an illumination pattern through refraction.

9. The lighting device according to claim 5, wherein the optic comprises a plurality of optics.

10. The lighting device according to claim 5, wherein a totally internally reflective surface of the optic is circularly symmetric.

11. The lighting device according to claim 5, wherein the light source comprises a scanning mirror, and the lighting device further comprising a controller configured to control a position of the scanning mirror.

12. The lighting device according to claim 11, wherein the light source further comprises a plurality of light emitting diodes (LED) and a plurality of scanning mirrors, each LED of the plurality of LEDs corresponding to one scanning mirror of the plurality of scanning mirrors.

13. A method for lighting an interior space having at least one wall and a ceiling adjacent to the wall, the at least one wall and ceiling forming at least one corner portion, comprising:
using a strip illuminating structure to provide light to the at least one corner portion; and controlling a light source to selectively distribute the light from sections of the strip illuminating structure.

14. The method according to claim 13, wherein controlling includes controlling the light source to distribute light from two sections of the strip illuminating structure in directions different from one another.

15. The method according to claim 13, wherein providing light to the at least one corner portion includes placing the light source in the at least one corner portion.

16. The method according to claim 13, wherein providing light to the at least one corner portion includes projecting light into one or more predetermined sections of the strip illuminating structure.

17. The method according to claim 13, wherein controlling the light source includes controlling at least two light sources.

18. The method according to claim 13, further comprising selecting a length of the light source to correspond to a length of the wall.

19. The method according to claim 13, further comprising placing the light source on the ceiling a predetermined distance from the at least one wall.

20. The method according to claim 13, wherein controlling the light source includes controlling at least two light sources, a first light source of the at least two light sources positioned on the ceiling and a second light source of the at least two light sources positioned at the cornice.

21. The method according to claim 20, wherein placing the light source on the ceiling includes placing the light source in a center of the ceiling.

22. The method according to claim 19, further comprising arranging the light source to illuminate at least a portion of the ceiling so as to reflect light from the ceiling into the interior space.

23. The method according to claim 19 further comprising projecting light from the at least one light source toward the cornice, and reflecting the projected light from the cornice into an area of the interior space.

24. The method according to claim 23, further comprising using a reflective sheet at the cornice to reflect the projected light from the cornice.

25. The method according to claim 24, wherein using a reflective sheet includes using a reflective sheet that reflects light using at least one of mirror surfaces or total internal reflection.

26. The method according to claim 20, further comprising placing the light source remote from the cornice, and using a scanning mirror to project light toward the cornice.

27. The method according to 26, further comprising collimating the light prior to projecting the light toward the cornice.

28. The method according to claim 13, wherein controlling the light source includes using a light source comprising a light guide as the light source, said light guide having at least one input surface for receiving light and an exit surface for emitting the received light;

29. The method according to claim 28, further comprising configuring the exit surface of the light guide to compensate for fall-off intensity proportional to cost.

30. The method according to claim 28, wherein controlling the light source includes using extraction features having a prism-based geometry to control a direction of light emitted by the light source.

31. The method according to claim 30, wherein using extraction features includes arranging the extraction features such that a feature density in a given area corresponds to a distance of the extraction features from the at least one input surface.

32. The method according to claim 13, wherein controlling the light source includes using a pre-existing light source in the interior space.

33. The method according to claim 13, further comprising controlling an emission brightness from portions of the light source to control an illumination pattern in the interior space.
